(19) United States
(12) Patent Application Publication
(10) Pub. No.: US 2017/0145978 A1
(43) Pub. Date: May 25, 2017

(54) MOTOR VEHICLE STARTER

(71) Applicant: VALEO EQUIPEMENTS ELECTRIQUES MOTEUR, Creteil Cedex (FR)

(72) Inventors: Fabrice MARSAC, Lyon (FR); José MATEUS, Champagne au Mont D'or (FR); Jacques VEROT, Lyon (FR)

(73) Assignees: VALEO EQUIPEMENTS ELECTRIQUES MOTEUR, Creteil Cedex (FR); VALEO EQUIPEMENTS ELECTRIQUES MOTEUR, Creteil Cedex (FR)

(21) Appl. No.: 15/321,499

(22) PCT Filed: Jun. 2, 2015
(86) PCT No.: PCT/FR2015/051443

§ 371 Date: Dec. 22, 2016

(30) Foreign Application Priority Data
Jun. 24, 2014 (FR) 1455824

(51) Int. Cl. F02N 15/06; F02N 11/10; F02N 11/08

(52) U.S. Cl. CPC F02N 15/067; F02N 11/087; F02N 11/106

(57) ABSTRACT

An electric starter of an internal combustion engine, specifically a starter of an internal combustion engine of a motor vehicle, the starter comprising: a starter drive assembly mobile between an inoperative position and an operative position in which the starter drive assembly is capable of starting the internal combustion engine; an electric motor capable of rotating the starter drive assembly about an axis of rotation; a control lever arranged so as to move the starter drive assembly axially, the control lever being capable of pivoting about a pivoting axis, the pivoting axis being movable over a predetermined linear stroke from an inoperative position to a lever pressing position in which the lever can pivot so as to bring the starter drive assembly into the operative position, the control lever including at least one block arranged such as to engage with the starter drive assembly.

The present invention relates in particular to an electric starter of an internal combustion engine, and more particularly to a starter of an internal combustion engine of a motor vehicle.

Patent application FR 2 872 551 describes a motor vehicle starter comprising a lever end surface opposite the frontal face of the mobile launcher, which face is formed in the shape of a cam.

The objective of the present invention is to improve this type of starter.

The subject of the invention is thus an electric starter of an internal combustion engine, and more particularly a starter of an internal combustion engine of a motor vehicle, this starter comprising:
a launcher which is mobile between a position of rest and an active position, in which the launcher can start the internal combustion engine;
an electric motor which can rotate the launcher around an axis of rotation;
a control lever which is designed to displace the launcher axially, the control lever being able to pivot around a pivoting shaft, this pivoting shaft being mobile on a predetermined linear course, from a position of rest to a lever support position, in which the lever can pivot in order to bring the launcher into the active position, this control lever comprising at least one runner which is designed to cooperate with the launcher,
   characterised in that, during the functioning of the starter, and in the case of blocking of the launcher in the active position, in particular in the case of blocking of the launcher in a crown of the internal combustion engine, the electrical cut-off of the electric motor of the starter is obtained by the displacement of the pivoting shaft from its lever support position to its position of rest, and by the displacement of the runner relative to the launcher in a direction opposite the displacement of the pivoting shaft, from its lever support position to its position of rest.

With reference to the cut-off clearance which is necessary in order to deactivate a contactor of the starter electrically in the case of blocking of the launcher in the active position, the invention makes it possible to distribute this cut-off clearance on the displacement of the pivoting shaft and on the displacement of the runner. The variable runner clearance between the runner and the launcher makes it possible to reduce the amplitude of the displacement of the pivoting shaft of the control lever, without replacing it completely. It is important for the mobile core of the contactor to accumulate kinetic energy, in order to avoid any risk of blocking of the function Z when cold.

It will be remembered that the function Z makes it possible to displace the launcher, or the pinion of the launcher, axially, so that the pinion engages in the crown of the internal combustion engine during starting phases, and to extract the pinion from the engine crown once the starting has been carried out. The function Z consists in particular of the contactor, the mobile core which slides in the contactor, the lever which is coupled to the mobile core and mounted in the launcher which slides according to the axis of the rotor. In particular, grease is deposited between the mobile core and the contactor in order to guarantee good sliding and retention of the mobile core in the long term. However, at a low temperature the grease tends to congeal, which slows down or even blocks the movement of the mobile core. It is therefore important for the mobile core of the contactor to accumulate kinetic energy in order to avoid any risk of blocking.

Thus, in the position of rest of the control lever and the launcher, the variable clearance between the runner and the launcher is minimal, such that the unloaded course to be travelled by a mobile core of the contactor before thrusting the launcher is shorter. The kinetic energy accumulated by the mobile core is thus lower, and therefore its dissipation of energy in the tooth-against-tooth spring. i.e. the spring which thrusts the launcher towards engagement with the crown of the internal combustion engine, is also lower. The tooth-against-tooth spring is less compressed. The kinematics of the pinion are then increased, i.e. the distance travelled by the launcher before electrical closure of the contactor is increased, without having to modify the electric current consumed by the contactor during the tooth-against-tooth contact.

In an example of an embodiment of the invention, during the functioning of the starter, and in the case of blocking of the launcher in the active position, in particular in the case of blocking of the launcher in a crown of the internal combustion engine, the said variable runner clearance is arranged at the front of the runner, on the side of the starter where the launcher is located.

Preferably, during the functioning of the starter, and in the case of blocking of the launcher in the active position, in particular in the case of blocking of the launcher in a crown of the internal combustion engine, when the said variable runner clearance is generated, the runner is in support contact with the launcher at the rear of the runner, on the side opposite the side of the starter where the launcher is located.

Advantageously, the runner has a form which is designed to obtain a lever ratio of the control lever to the launcher, which ratio is constant or increasing on at least a portion of displacement of the launcher from the position of rest to the active position.

In an example of an embodiment of the invention, on the portion of displacement of the launcher from the position of rest to the active position, the control lever and the launcher are arranged such that the lever ratio varies by passing via a point of inflection.

The lever ratio is preferably contained between 1 and 1.7.

In the position of rest of the pivoting shaft and of the control lever, the distance between a front facet of the runner and a front support facet of the launcher is in particular zero in the case when the chain of dimensions of this clearance is minimum, and the clearance is positive in the case when the chain of dimensions of this clearance is maximal.

In the example of an embodiment of the invention, in a phase of withdrawal of the pivoting shaft corresponding to the withdrawal of the pivoting shaft of the control lever from the position of rest to the lever support position, without making the launcher slide, the variable runner clearance increases, but without reaching the clearance necessary in order to obtain the cut-off clearance which makes it possible to cut off the electrical supply of the motor. Then, in a phase of pivoting of the lever around its pivoting shaft in contact with the lever support, the variable runner clearance increases at the same time that the launcher slides forwards in order to be maximal once the pinion is in the active position. It is only when the pinion is in the active position, when the variable runner clearance is maximal, that the cut-off clearance is sufficient to cut off the electrical supply of the motor.

Preferably, the front facet of the runner of the control lever comprises a front cam which is arranged such as to be supported against a front support facet of the launcher, this cam being arranged such as to come into contact with the front support facet of the launcher according to an area of contact which is at a distance from the pivoting shaft, which distance is variable, and in particular increasing, when the control lever pivots in order to bring the launcher into the active position.

Advantageously, the front cam has a profile observed according to the pivoting shaft, which profile comprises at least one camber, in particular a profile in the form of at least one arc of a circle, and preferably in the form of a plurality of arcs of a circle with different radii of curvature.

The rear facet of the runner comprises in particular a rear cam with a profile observed according to the pivoting shaft, which profile comprises at least one camber, in particular a profile in the form of at least one arc of a circle, and preferably in the form of a plurality of arcs of a circle with different radii of curvature.

The arcs of a circle of the profiles of the front and rear cams of the runner are advantageously eccentric.

In an example of an embodiment of the invention, the camber, in particular the arc of a circle, of the rear cam, is further away from the pivoting shaft of the control lever than the camber, in particular the arc of a circle, of the front cam.

The cam provides the control lever with a ratio which is substantially constant, or increasing, in a functioning range, which means that the force available on the runner is maximum at the start of the course. This makes it possible to overcome better the inertia of the launcher, and increase the pressure force of the launcher against the crown of the combustion engine, which makes it possible to reduce the risk of milling.

In an example of an embodiment of the invention, the variable runner clearance is contained between 0.1 and 4 mm.

Advantageously, the translation of the pivoting shaft of the control lever in the withdrawal phase is contained between 0.5 and 2 mm.

Preferably, the cut-off clearance between the fixed and mobile cores of the contactor, obtained by means of the combination of the variable runner clearance and the translation of the pivoting shaft of the control lever in the advance phase, is contained between 2 mm and 5 mm.

The control lever comprises for example pins which form the pivoting shaft.

If required, the control lever is formed in a single piece.

The starter can comprise a slide in which the pivoting shaft of the control lever can be displaced in translation.

This slide can comprise a stop which is designed such as to stop the control lever in its lever support position.

In an example of an embodiment of the invention, this stop is formed on an insert added onto the starter, and in particular a plastic insert.

If applicable, the starter is designed to be able to start a number of cycles of more than 100,000, and in particular 200,000. The starter can for example provide a stop-start function.

The invention will be able to be better understood by reading the following detailed description of an example of a non-limiting embodiment of the invention, and by examining the appended drawing, in which:

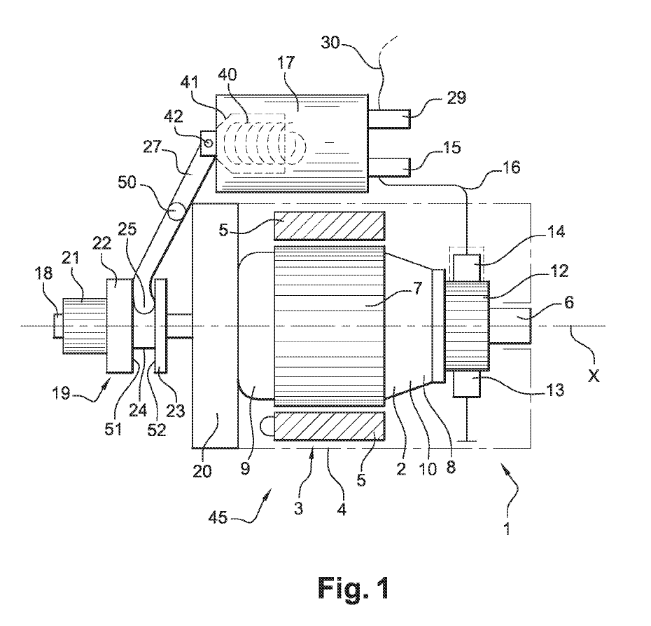

FIG. 1 represents schematically and partially a motor vehicle starter according to an example of an embodiment of the invention;

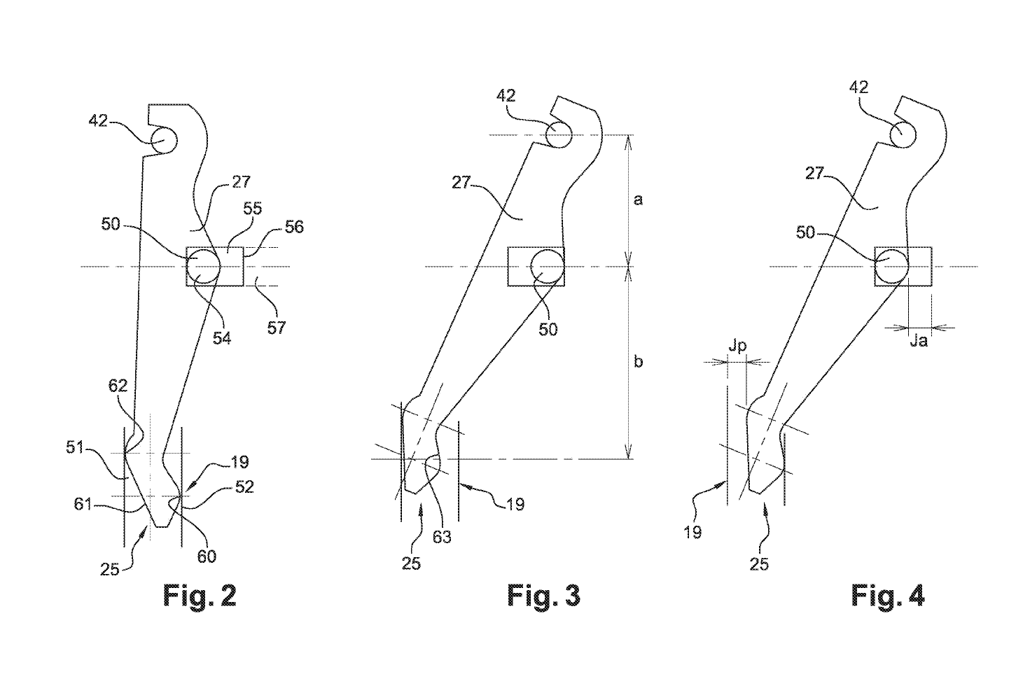

FIGS. 2 to 4 represent schematically and partially a detail of the starter in FIG. 1, respectively in three different functioning positions; and

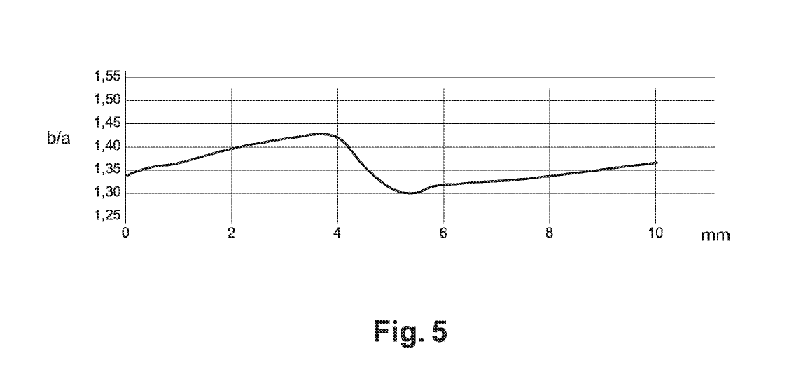

FIG. 5 illustrates schematically the variation of the lever ratio according to the displacement of the mobile core of a contactor of the starter in FIGS. 1 to 4.

FIG. 1 represents a rotary electrical machine which forms a starter 1 of a motor vehicle.

This starter 1 comprises firstly a rotor 2 also known as an armature, which can rotate around a longitudinal axis X such as to drive a rotor shaft 6, and secondly a stator 3, also known as an inductor, around the rotor 2.

The stator 3 comprises a yoke 4 which supports a plurality of permanent magnets 5.

The rotor 2 comprises a rotor body 7 which is arranged opposite magnets 5 of the stator 3, and a winding 8 which is wound in the notches in the rotor body 7.

The winding 8 comprises a plurality of conductive wires which form a front chignon 9 and a rear chignons 10 on both sides of the rotor body 7.

The stator 3 and the rotor 2 form part of an electric motor 45.

The rotor 2 is provided at the rear with a collector 12 comprising a plurality of contact parts which are connected electrically to the winding 8.

A set of brushes 13 and 14 is provided for the electrical supply of the winding 8, one of the brushes 13 being connected to the earth of the device 1, and another one of the brushes 14 being connected to an electrical terminal 15 of a contactor 17 via a wire 16.

The brushes 13 and 14 rub on the collector 12 when the rotor 2 is rotating.

In addition to the terminal 15 which is connected to the brush 14, the contactor 17 comprises a terminal 29 which is connected via an electrical connection element, in particular a wire 30, to an electrical supply of the vehicle, and in particular a battery, not represented.

The contactor 17 can activate a control lever 27, in order to displace a launcher 19 from a position of rest in which the launcher 19 is situated in the vicinity of the rotor 2, to an active position for driving of the combustion engine. In this active position, the launcher 19 can engage with a crown of the combustion engine in order to rotate it.

The launcher 19 comprises for example a free wheel 22 and a washer 23, which define between one another a groove 24 in order to receive the runner 25 of the control lever 27.

The runner 25 is doubled such as to form a fork which cooperates with the launcher.

The launcher 19 comprises a front support facet 51, for example on the free wheel 22, and a rear support facet 52, for example on the washer 23.

It will be appreciated that the launcher 19 can be produced in another way.

The launcher 19 is fitted such as to slide and rotate on a drive shaft 18.

The launcher 19 additionally comprises a drive element which is formed by a toothed pinion 21, and is designed to engage on a drive unit of the combustion engine, not represented. This drive unit is for example a crown.

A speed reducer 20 is interposed between the rotor 2 and the drive shaft 18, such as to adapt the speed of the rotor 2 to the driving of the combustion engine.

This speed reducer 20 comprises an assembly comprising a toothed crown in which sun gears and planet wheels are arranged in a known manner.

The contactor 17 is designed such as to permit the following:
when the starter is at a standstill, and is not functioning, a spring 40 of the contactor 17 thrusts the control lever forwards, i.e. towards the side of the starter where the launcher 19 is located;
when the contact key of the vehicle is turned, an electromagnet displaces a mobile core 41 of the contactor 17, which core 41 draws the control lever 27 rearwards, this lever 27 being connected to the core 41 by an articulation 42; during this withdrawal phase, the launcher 19 is immobile;
when the mobile core 41 continues to withdraw, the control lever 27 via the runner 25 thrusts the launcher 19 towards the crown to be driven; the mobile core continues its course until it abuts against a fixed core of the contactor 17.

In the example illustrated, the control lever 27 is designed to displace the launcher 19 axially, the control lever being able to pivot around a pivoting shaft 50, this pivoting shaft 50 being mobile on a predetermined linear course, from a position of rest to a lever support position, in which the lever can pivot in order to bring the launcher 19 into the active position.

The control lever 27 comprises pins 54 which form the pivoting shaft 50, as illustrated in FIG. 2.

In the example described, the control lever 27 is produced in a single piece.

The starter comprises a slide 55 in which the pivoting shaft 50 of the control lever can be displaced in translation.

This slide 55 can comprise a stop 56, which is designed to stop the control lever in its lever support position.

This stop is formed on an insert 57 which is added onto the starter, in particular a plastic insert.

During the functioning of the starter, and in the case of blocking of the launcher in the active position, in particular in the case of blocking of the launcher in the crown of the internal combustion engine, the electrical cut-off of the electric motor 45 of the starter is obtained by displacement of the pivoting shaft 50 on a distance Ja from its lever support position to its position of rest, as well as by displacement of the runner on a distance Jp from its position on the front support facet of the launcher 51, to the rear facet of the launcher 52, thus allowing the control lever 27 to pivot such as to obtain a cut-off clearance between the small plate of the contactor and the terminals 29 and 15, which leads to the axial displacement forwards of the cut-off clearance value coupling shaft.

The runner 25 has a form which is designed to obtain a lever ratio of the control lever to the launcher, which ratio is constant or increasing on at least one portion of displacement of the launcher, from the position of rest to the active position.

The lever ratio represents the ratio b/a between the distances a and b, “a” being the vertical projection of the distance between the pivoting shaft 50 and the articulation 42, and “b” being the vertical projection of the distance between the runner 25 and the pivoting shaft 50, as illustrated in FIG. 3.

On the portion of displacement of the launcher from the position of rest to the active position, the control lever and the launcher are arranged such that the lever ratio b/a varies by passing via one or a plurality of points of inflection.

This development can be seen in FIG. 5.

At the right of this curve in FIG. 5, the mobile core 41 is at its maximum distance from the fixed core, and the control lever and the launcher are in the position of rest.

At the left of this curve, there is magnetic contact in the contactor 17, the mobile core 41 being at the end of its course.

This curve shows that the lever ratio b/a has a point of inflection.

The lever ratio is preferably contained between 1.0 and 1.7.

In a phase of withdrawal of the pivoting shaft corresponding to the withdrawal of the pivoting shaft of the control lever from the position of rest to the lever support position without making the launcher slide, the variable runner clearance increases, but without reaching the clearance necessary in order to obtain the cut-off clearance which makes it possible to cut off the electrical supply of the motor. Then, in a phase of pivoting of the lever around its pivoting shaft in contact with the lever support, the variable runner clearance increases at the same time that the launcher slides forwards, in order to be maximal once the pinion is in the active position. It is only when the pinion is in the active position, when the variable runner clearance is maximal, that the cut-off clearance is sufficient to cut off the electrical supply of the motor.

The front facet 61 of the runner of the control lever comprises a front cam 62 which is designed to be supported against a front support facet 51 of the launcher, this cam being arranged such as to come into contact with the front support facet 51 of the launcher according to a contact area which is at a distance from the pivoting shaft, which distance is variable, in particular increasing, when the control lever 27 pivots in order to bring the launcher into the active position.

Advantageously, the front cam 62 has a profile observed according to the pivoting shaft 50, which profile comprises at least one camber, in particular a profile in the form of at least one arc of a circle.

The rear facet 60 of the runner comprises a rear cam 63, with a profile observed according to the pivoting shaft, which profile comprises a plurality of arcs of a circle with different radii of curvature.

The arcs of a circle of the profiles of the front 63 and rear 62 cams of the runner are advantageously eccentric.

In an example of an embodiment of the invention, the arc of a circle of the rear cam 63 is further from the pivoting shaft of the control lever than the arc of a circle of the front cam 62.

The cam 63 provides the control lever with a ratio which is substantially constant, or increasing, in a functioning range, which means that the force available on the runner is maximum at the start of the course. This makes it possible to overcome better the inertia of the launcher, and increase the pressure force of the launcher against the crown of the combustion engine, which makes it possible to reduce the risk of milling.

In an example of an embodiment of the invention, the variable runner clearance is contained between 0.1 and 4 mm.

Advantageously, the translation of the pivoting shaft of the control lever in the withdrawal phase is contained between 0.5 mm and 2 mm.

The cut-off clearance between the fixed and mobile cores of the contactor obtained with the combination of the variable runner clearance and the translation of the pivoting shaft of the control lever in the phase of advance, is contained between 2 mm and 5 mm.

1. Electric starter (1) of an internal combustion engine, and more particularly a starter of an internal combustion engine of a motor vehicle, this starter comprising:
a launcher (19) which is mobile between a position of rest and an active position, in which the launcher can start the internal combustion engine;
an electric motor (45) which can rotate the launcher around an axis of rotation (X);
a control lever (27) which is designed to displace the launcher axially, the control lever being able to pivot around a pivoting shaft (50), this pivoting shaft being mobile on a predetermined linear course (Ja), from a position of rest to a lever support position, in which the lever can pivot in order to bring the launcher into the active position, this control lever comprising at least one runner (25) which is designed to cooperate with the launcher,
wherein, during the functioning of the starter, and in the case of blocking of the launcher in the active position, in particular in the case of blocking of the launcher in a crown of the internal combustion engine, the electrical cut-off of the electric motor of the starter is obtained by the displacement of the pivoting shaft from its lever support position to its position of rest, and by the displacement of the runner relative to the launcher in a direction opposite the displacement of the pivoting shaft, from its lever support position to its position of rest.

2. Starter according to claim 1, wherein, during the functioning of the starter, and in the case of blocking of the launcher in the active position, in particular in the case of blocking of the launcher in a crown of the internal combustion engine, said variable runner clearance (Jp) is arranged at the front of the runner, on the side of the starter where the launcher is located.

3. Starter according to claim 1, wherein, during the functioning of the starter, and in the case of blocking of the launcher in the active position, in particular in the case of blocking of the launcher in a crown of the internal combustion engine, when said variable runner clearance (Jp) is generated, the runner is in support contact with the launcher at the rear of the runner, on the side opposite the side of the starter where the launcher is located.

4. Starter according to claim 1, wherein the runner (25) has a form which is designed to obtain a lever ratio (b/a) of the control lever to the launcher, which ratio is constant or increasing on at least a portion of displacement of the launcher from the position of rest to the active position.

5. Starter according to claim 4, wherein, on the portion of displacement of the launcher from the position of rest to the active position, the control lever and the launcher are arranged such that the lever ratio varies by passing via one or a plurality of points of inflection.

6. Starter according to claim 1, wherein, in a phase of withdrawal of the pivoting shaft (50) corresponding to the withdrawal of the pivoting shaft of the control lever from the position of rest to the lever support position, without making the launcher slide, the variable runner clearance increases.

7. Starter according to claim 1, wherein, the front facet (61) of the runner of the control lever comprises a front cam (62) which is arranged such as to be supported against a front support facet of the launcher, this cam being arranged such as to come into contact with the front support facet of the launcher according to an area of contact which is at a distance from the pivoting shaft, which distance is variable, and in particular increasing, when the control lever pivots in order to bring the launcher into the active position.

8. Starter according to claim 1, wherein the front cam (62) has a profile observed according to the pivoting shaft, which profile comprises at least one camber, in particular a profile in the form of at least one arc of a circle, and preferably in the form of a plurality of arcs of a circle with different radii of curvature.

9. Starter according to claim 1, wherein the rear facet (60) of the runner comprises a rear cam (62) with a profile observed according to the pivoting shaft, which profile comprises at least one camber, in particular a profile in the form of at least one arc of a circle, and preferably in the form of a plurality of arcs of a circle with different radii of curvature.

10. Starter according to claim 7, wherein the arcs of a circle of the profiles of the front (62) and rear (63) cams of the runner are eccentric.

11. Starter according to claim 10, wherein the camber, in particular the arc of a circle, of the rear cam, is further away from the pivoting shaft of the control lever than the camber, in particular the arc of a circle, of the front cam.

12. Starter according to claim 1, wherein the variable runner clearance (Jp) is contained between 0.1 and 4 mm.

13. Starter according to claim 2, wherein, during the functioning of the starter, and in the case of blocking of the launcher in the active position, in particular in the case of blocking of the launcher in a crown of the internal combustion engine, when said variable runner clearance (Jp) is generated, the runner is in support contact with the launcher at the rear of the runner, on the side opposite the side of the starter where the launcher is located.

14. Starter according to claim 2, wherein the runner (25) has a form which is designed to obtain a lever ratio (b/a) of the control lever to the launcher, which ratio is constant or increasing on at least a portion of displacement of the launcher from the position of rest to the active position.

15. Starter according to claim 3, wherein the runner (25) has a form which is designed to obtain a lever ratio (b/a) of the control lever to the launcher, which ratio is constant or increasing on at least a portion of displacement of the launcher from the position of rest to the active position.

16. Starter according to claim 2, wherein, in a phase of withdrawal of the pivoting shaft (50) corresponding to the withdrawal of the pivoting shaft of the control lever from the position of rest to the lever support position, without making the launcher slide, the variable runner clearance increases.

17. Starter according to claim 3, wherein, in a phase of withdrawal of the pivoting shaft (50) corresponding to the withdrawal of the pivoting shaft of the control lever from the position of rest to the lever support position, without making the launcher slide, the variable runner clearance increases.

18. Starter according to claim 4, wherein, in a phase of withdrawal of the pivoting shaft (50) corresponding to the withdrawal of the pivoting shaft of the control lever from the position of rest to the lever support position, without making the launcher slide, the variable runner clearance increases.

19. Starter according to claim 5, wherein, in a phase of withdrawal of the pivoting shaft (50) corresponding to the withdrawal of the pivoting shaft of the control lever from the position of rest to the lever support position, without making the launcher slide, the variable runner clearance increases.

20. Starter according to claim 8, wherein the arcs of a circle of the profiles of the front (62) and rear (63) cams of the runner are eccentric.
